(19) United States
(12) Patent Application Publication
(10) Pub. No.: US 2026/0152376 A1
(43) Pub. Date: Jun. 4, 2026

(54) FOAM ON FLUID DETECTOR

(71) Applicant: Kenneth Simpson, Shrewsbury Shropshire (GB)

(72) Inventor: Kenneth Simpson, Shrewsbury Shropshire (GB)

(21) Appl. No.: 19/122,392

(22) PCT Filed: Oct. 2, 2023
(86) PCT No.: PCT/EP2023/077241

§ 371 Date: Apr. 18, 2025

(30) Foreign Application Priority Data
Oct. 27, 2022 (GB) 2215888.5
Feb. 3, 2023 (GB) 2301553.0

(51) Int. Cl. B67D 1/12

(52) U.S. Cl. CPC B67D 1/1247

(57) ABSTRACT

A foam on fluid detector 1 has a bowel chamber 6 arranged to provide a fluid pathway between a keg connection port 4 and a tap connection port 5, the chamber having a ball valve or float 8 that in a seated position closes the fluid pathway between the container and tap connection ports, the detector having a purging port 3 and a control chamber between the ports, wherein the control chamber has a valve system operable by an actuator 18 to simultaneously open and close at least two of the ports to alter fluid flow through the ports. The detector enables dispensing, shut-off and purging to be carried out by movement of a single actuator on the detector.

### FIELD OF THE INVENTION

The present invention relates generally to a fluid dispensing apparatus and to a method of dispensing fluid from a container, in particular in relation to a beverage keg.

### BACKGROUND OF THE INVENTION

Beer, larger, cider and real ale can be provided in a variety of containers, such as bottles, cans casks and kegs. Real ales are dispensed from casks. However, beer, larger and cider are usually dispensed from kegs. A keg requires pressure to be applied to the fluid, such as beer, in the keg in order to get it from the keg to the tap in the bar for serving. An inert gas like nitrogen or carbon dioxide is introduced into the container which forces beer at the bottom to exit the container and be delivered to a tap through a beer line. A problem arises when all the beer has been dispensed out of the keg as this can then result in the gas being delivered to the tap which is undesirable, since it can cause splashing and wastes any beer remaining in the line.

This problem has been addressed by providing a foam on beer (FOB) detectors in the fluid supply line between the keg and the tap, particularly where there is a long draw line for delivering the beverage from keg to tap. The FOB detector detects when the keg is empty and stops beer flow. This ensures that the beer line remains full, instead of filling with foam and more importantly it prevents people getting splashed from the foam that could come out of the tap in the bar. The device works by placing a bowel chamber with a float or ball valve in the fluid line. When the beer is flowing, the float or ball valve lies on top of the beer in the bowel chamber allowing the beverage to be dispensed through the beer line. However, when the keg empties the float or ball valve drops down to the bottom of the bowel chamber due to there being no fluid in the bowel. In this lowered position, the float or ball valve seals the exit from the bowel chamber and in doing prevents gas and foam entering the beer line and eventually coming out of the tap in the bar where it could splash people.

There are various types of foam on beer (FOB) detectors on the market which operate in slightly different ways, but all require a number of user actions once a keg is empty and a new keg has to be fitted to the line. The detector includes a vent or purging mechanism, which conventionally requires a spring-loaded button to be pressed, to allow purging of the system to release gas or foam from the bowel chamber and to fill the supply tube from the keg with fluid from the new full keg. Once the purging is complete, a separate rotatable knob or another button is then provided which must be activated to release the seal between the float/ball valve and the bottom of the bowel chamber. Beer is then able to flow from a new full keg back into the bowel chamber (to lift the float or ball valve) and onwards to the tap in the bar. The knob or button must then be deactivated to ensure that the FOB detector operates correctly. Otherwise, if the rotatable knob or button are not deactivated this will mean the float/ball valve is prevented from forming a seal at the bottom of the bowel when the next keg is empty. In these circumstances when the float/ball valve is prevented from forming a seal the gas and foam from the next empty keg will pass through the FOB detector and come out of the tap and splash people in the bar.

These types of FOB detectors are common in the trade and are entirely acceptable for purpose. However, it is desirable to improve the prior art by providing a FOB detector that requires less user actions, is easier to operate and there is no chance of foam getting through to the tap in the event of the float/ball valve rotatable knob or button having not been deactivated at the end of purging.

It is an object of the present invention to provide an improved foam on fluid detector, fluid dispensing apparatus and method of dispensing fluid from a container, particularly but not exclusively a keg, that aim to overcome, or at least alleviate, the abovementioned drawbacks.

### SUMMARY OF THE INVENTION

According to a first aspect of the present invention there is provided a foam on fluid detector comprising a bowel chamber arranged to provide a fluid pathway between a fluid container connection port and a tap connection port, the bowel chamber having a ball valve or float that in a seated position closes the fluid pathway between the container and tap connection ports, the detector further comprising a purging port and a control chamber between the ports, wherein the control chamber has a valve system operable by an actuator to simultaneously open and close at least two of the ports to alter fluid flow through the ports.

Preferably, the actuator and valve system simultaneously close the tap connection port and open the purging port, i.e., reversing the exit of one of the ports. Similarly, the actuator and valve system simultaneously open the tap connection port and close the purging port. More preferably, opening of the purging port by the actuator and valve system simultaneously provides a fluid pathway between the fluid container connection port and the ball valve or float.

Preferably the valve system of the control chamber comprises a spool valve. The actuator preferably affects axial or rotational movement of the spool valve to simultaneously open and close two or more of the ports. The valve system preferably includes multiple seal members for each of the ports. The seal members may comprise O rings, preferably being perpendicular to the spool valve. The seal members may be angled to the spool valve. In alternative embodiments, the valve system may comprise a rotating disc valve or cam that opens spring loaded valves.

The actuator may comprise a button, switch or lever. In one embodiment, the actuator is a button connected to one end of the spool valve for axial movement of the spool valve. In an alternative embodiment, the actuator may comprise a level or handle rotation of which causes rotational movement of the spool valve. Alternatively, an automatic actuator may be connectable to the valve system, for example a solenoid.

Preferably, the detector comprises a main body port for receiving the bowel chamber. Preferably, a seal member is provided between the main body part and the bowel chamber.

The main body part preferably includes the connection ports, purging port, control chamber with valve system and the actuator. More preferably, a tube is provided from the control chamber to the top of the bowel chamber.

In a preferred embodiment, the fluid container connection port and the tap connection port are provided adjacent one another, preferably below the control chamber. However, it is to be appreciated that the ports may be provided in different configurations.

The fluid container preferably comprises a keg.

It is preferable to provide a fixing assembly for quickly attaching the keg connection port and the tap connection port to their respective fluid lines. More preferably, each assembly comprises a gripper moulding, an O ring and a retaining moulding.

Preferably, the purging port is open to atmosphere. However, it is to be appreciated that is could be connected to a waste fluid and gas line.

Thus, the detector according to the first aspect of the present invention has a dispensing position, an automatic shut-off position and a purging position. Preferably, the shut-off position is affected by seating of the ball valve or float at the base of the bowel chamber due to a lack of fluid flow from the fluid container. Actuation of the valve system switches the detector between the dispensing position and the purging position. More preferably, the actuator is biased towards the dispensing position. In one embodiment, a spring is provided between the spool valve and the actuator, for example a button, the spring biasing the button and valve to the dispensing position. Alternatively, or additionally, the spool valve or other similar valve system may be biased towards the dispensing position by pressure inside the control chamber.

In the case of a rotating spool valve or disc valve again a radial clock type spring biases the valve to the dispense position.

Preferably, actuation of the valve system to switch the detector to the purging position simultaneously moves the valve system to create a fluid pathway between the fluid container port and an underside of the ball valve or float in the bowel chamber. This allows pressure from the fluid container to push the ball valve/float off its seat while simultaneously enabling unwanted gas and foam to flow from the fluid container to the bowel chamber, preferably exiting the chamber via the tube with its open end at the highest point possible inside the bowel and out of the purging port to exit to atmosphere.

A second aspect of the present invention provides a fluid dispensing system comprising;
a container of pressurized gas;
a gas line connected to the container of pressurized gas and to a container containing a fluid to be dispensed;
a fluid line from the container to the fluid container connection port of a foam on fluid detector according to the first aspect of the present invention; and
a fluid line from the tap connection port of the foam on fluid detector to a tap for dispensing fluid through the tap.

Preferably at least one pressure regulator is provided in the gas line between the pressurized gas container and the fluid container. The fluid container preferably comprises a keg with the fluid container connection port comprising a keg connection port.

In a dispensing mode, when the ball valve or float is floating in the bowel, fluid from the keg travels through the keg connection port, preferably up a tube to the top of the bowel, and then onwards through the bowel chamber of the detector, through the tap connection port to the fluid line to the tap. Once the keg becomes empty, the ball valve or float in the detector falls to a seated position, blocking off flow to the tap connection port. A new keg can then be fitted by transferring a standard keg connector from the empty keg to the full keg. The actuator of the detector is then operated to control the valve system of the detector to switch flow of the keg connection port to under the ball valve or float. This lifts the ball valve or float off the sealing surface in the bottom of the bowel chamber. The bowel chamber receives the foam in the supply line and then exits the bowel via the open end of the tube at the top of the bowel finally then exiting through (to) the purging port to atmosphere. Once purging is complete, which is when liquid starts to flow from the purging port, the actuator is deactivated to switch flow back to the tap connection port.

A third aspect of the present invention provides a method of dispensing a fluid from a container to a tap, the method comprising:
delivering pressurized gas to a container of fluid;
delivering pressurized fluid to a fluid container connection port of a foam on fluid detector according to the first aspect of the present invention, wherein the fluid lifts the ball valve or float in the bowel chamber of the detector for delivery of fluid to the tap connection port;
delivering fluid through the tap connection port to a tap for dispensing of the fluid until the container is empty wherein the ball valve or float falls to the bottom of the bowel chamber to prevent gas and fluid flow to the tap connection port;
the method further comprising replacing the empty fluid container with a full container and activating the actuator of the detector to simultaneously open the purging port and lift the ball valve or float.

Preferably, the fluid container is a keg.

More preferably, activating the actuator to open the purging port simultaneously operates the valve system to provide a fluid pathway from the keg connection port to an underside of the ball valve in the bowel chamber of the detector. In this manner, pressure from the keg pushes the ball valve off its seal and unwanted gas and foam/fob flows from the keg into the bowel chamber. Activation of the actuator has also opened up the bowel tube to the purging port to atmosphere.

Preferably the method further comprises deactivating the actuator to simultaneously close the purging port, redirect the fluid coming in from the fluid connection to go from under the ball valve to go through the tube inside the bowel exiting at the high point of the tube and re-open the tap connection port, allowing fluid flow from the keg to the tap.

### BRIEF DESCRIPTION OF THE DRAWINGS

For a better understanding of the present invention and to show more clearly how it may be carried into effect, reference will now be made by way of example only to the accompanying drawings in which:

FIG. 1 is a schematic diagram of a beer keg dispensing system incorporating a foam on beer (FOB) detector according to one embodiment of the present invention;

FIG. 2A is a front view of a foam on beer detector according to one embodiment of the present invention;

FIG. 2B is a sectional side view through line A-A of FIG. 2A;

FIG. 2C is a side view of the beer on foam detector of FIG. 2A;

FIG. 2D is sectional view through line B-B of FIG. 2C;

FIG. 3A is an expanded sectional view of the beer on foam detector of FIGS. 2A-2D, shown in a dispensing position;

FIG. 3B is an expanded sectional view of the beer on foam detector of FIGS. 2A-2D, shown in a shut-off position;

FIG. 3C is an expanded sectional view of the beer on foam detector of FIGS. 2A-2D, shown in a purging position;

FIG. 4A illustrates a keg or tap connecting port of the FOB detector of FIGS. 2A to 3C;

FIG. 4B is an exploded view of the fittings for attachment of dispensing tubes to the port shown in FIG. 4A;

FIG. 4C shows the fittings of FIG. 4C assembled within a port of FIG. 4A;

FIG. 5A is a sectional view of a foam on beer detector according to another embodiment of the present invention, shown in a dispensing position; and

FIG. 5B is a sectional view of the foam on beer detector of FIG. 5A, shown in a purging position.

### DETAILED DESCRIPTION

The present invention provides a novel foam on beer (FOB) detector for placement within the dispensing system of a beer keg, albeit it is to be appreciated that other types of fluids may be dispensed from the keg, such as cider. Thus, the invention is not limited to beer dispensing as such and therefore in the context of this disclosure “foam on fluid” refers to a detector for use with any type of fluid.

FOB detectors are used to prevent a rush of unwanted liquid and gas coming out of a dispensing tap when the keg becomes empty. This rush of liquid and gas is wasteful and can also be embarrassing and unpleasant if it comes out of the tap in the bar and splashes people. Standard FOB detectors prevent this from happening by having a bowel chamber in the fluid line that is filled with liquid from the keg when in the dispense mode and then the liquid exits out through a port at the bottom of the detector body. There is a ball valve that floats in the liquid inside the bowel chamber. When the keg becomes empty, no liquid flows into the bowel chamber and so the ball sinks to the bottom of the bowel chamber and forms a seal over the exit port at the bottom of the chamber. The ball forming a seal over the bottom exit port prevents the rush of liquid and gas that could come from the empty keg. However, liquid is then trapped between the bowel chamber and the tap, requiring a purging step to be carried out to purge out all the gas and residual liquid in the line between the newly fitted keg and the FOB detector. Once purging is completed, the supply from the keg to the tap in the bar is finally restored without any gas or residual liquid in the supply line.

Prior art foam on fluid or FOB detectors require a number of user actions to purge the system. For example, a spring-loaded FOB button may be provided at the top of the bowel chamber which is pressed downwardly until the supply tube from the keg is purged with liquid from the full keg. Also, gas and residual liquid will come out of the FOB tube to atmosphere. A button at the bottom of the body is then pushed upwardly to release the ball which is forming a seal at the exit port at the bottom of the bowel. Once the ball is floating in the bowel, the button at the bottom of the body is pulled down. If this button remains pushed up, which can easily happen by mistake, then when the keg becomes empty the unwanted gas and residual liquid will come out of the tap in the bar, rendering the FOB detector of no use.

The device of the present invention is an improvement over prior art FOB detectors because dispensing, shut-off and purging is all carried out by movement of a single actuator on the FOB detector, resulting in the FOB detector being much easier to operate. This has the added benefit that the FOB is also more likely to be used correctly, reducing beer waste. Also, it means there is no chance of the present invention being rendered of no use as in the prior art. This is because in this invention there is no separate button to lift the float/ball valve off its seal. In this invention this function is achieved when a full keg is fitted to the keg port as it enables purging and lifting of the float/ball valve simultaneously.

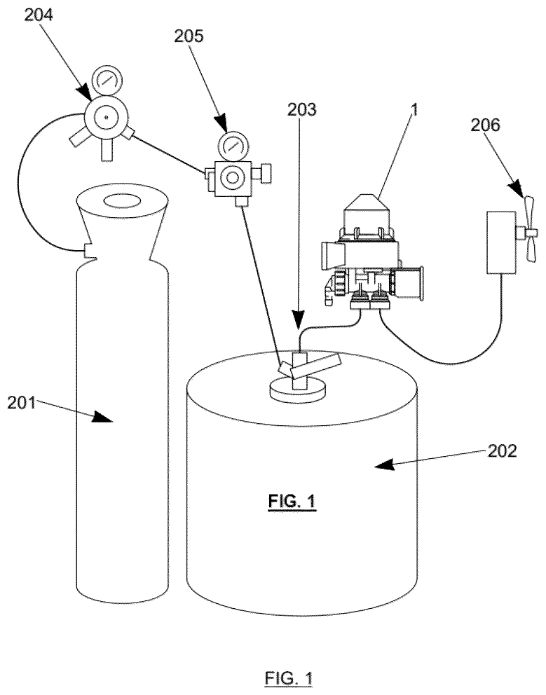

FIG. 1 of the accompanying drawings illustrates the positioning of a FOB detector within a dispensing system of a beer keg. This arrangement is standard in the industry but the particular detector 1 is novel and inventive over those previously incorporated into such dispensing systems as discussed in further detail below in relation to later figures. The keg 202 which includes the fluid to be dispensed, such as beer, is connected to a pressurized gas source 201, such as a container of carbon dioxide or nitrogen. Primary and secondary gas regulators 204, 205 regulate the introduction of gas into the keg 202 via a keg connector 203. The keg connector 203 also connects tubing from the keg to a dispensing tap 206, via the FOB detector 1. The FOB detectors prevents gas being dispensed from the tap 206 once the keg is empty.

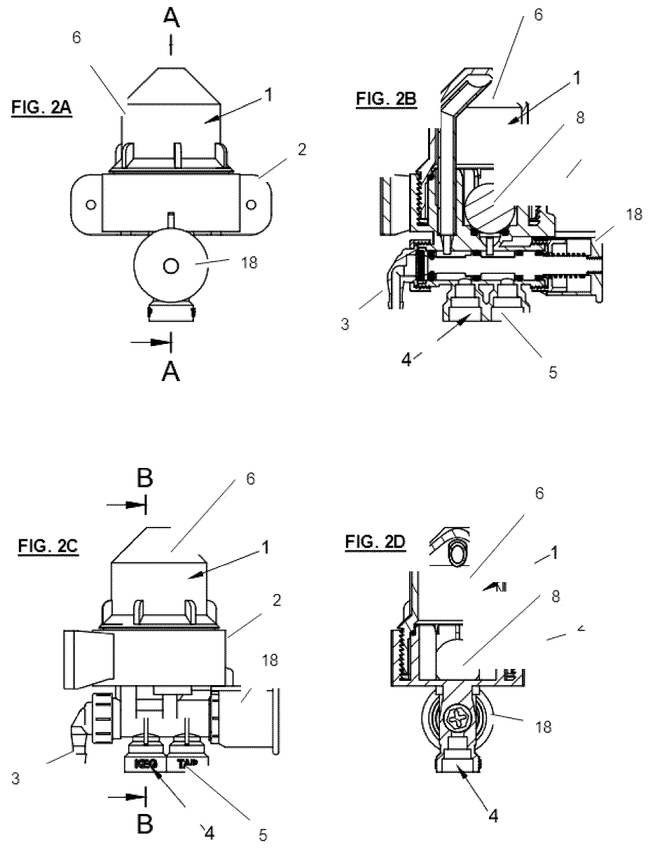

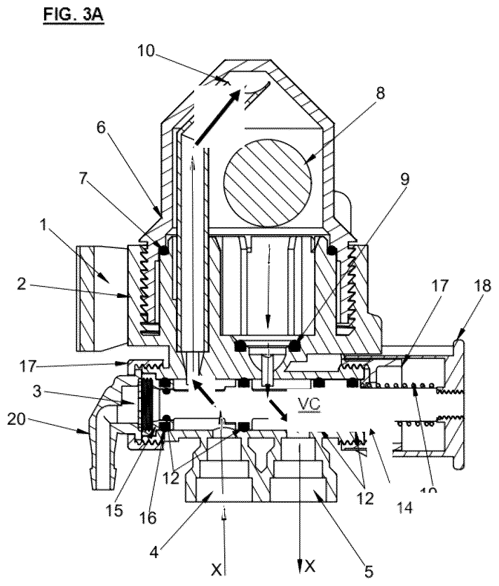

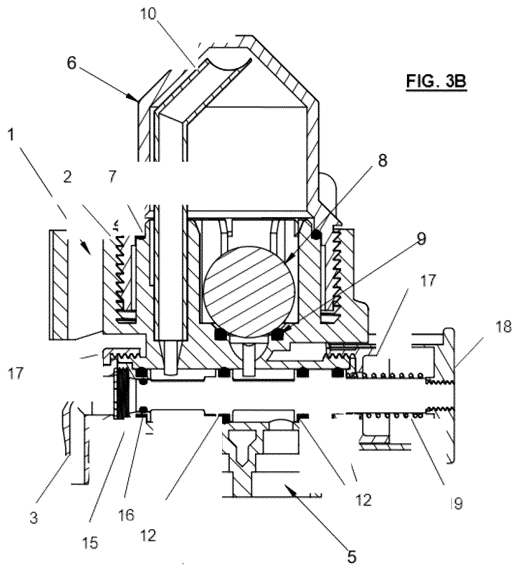

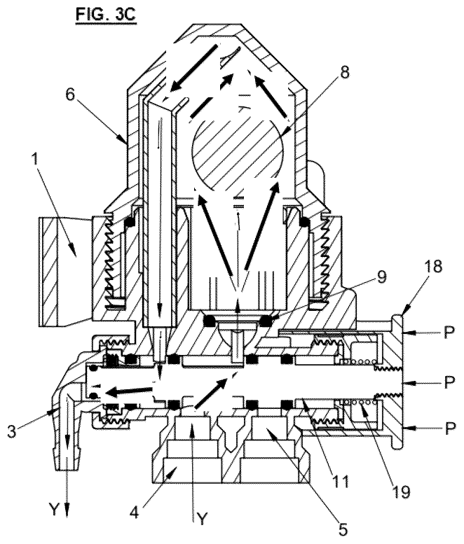

FIGS. 2A to 3C illustrate one embodiment of an improved FOB detector according to the present invention. In the figures, the detector is not shown connected to a dispensing system for the sake of simplicity, but it is to be appreciated that appropriate fluid lines would be connected to the ports, as is known in the art. FIGS. 2A and 2C show respectively the front and side views of the detector, a sectional side view of FIG. 2A is shown through line A-A in FIG. 2B and a sectional view of FIG. 2C through line B-B is shown in FIG. 2D. The ball valve 8 is shown in its lowermost position, shutting off fluid flow through the detector. The FOB detector 1 has a main body part 2 connected to a bowel chamber 6 provided with a ball valve or float 8. The detector has a keg connection port 4, a tap connection port 5 and a FOB or purging port 3, together with a control chamber having valve system controlled by a single actuator 18, which in this embodiment comprises a spring-mounted button 18. The valve system is discussed in further detail with reference to FIGS. 3A to 3C below.

Expanded views of the detector are shown in FIGS. 3A to 3C. The FOB detector 1 has a body 2 with three ports, a purging or FOB exit port 3, a keg connection port 4 for connection to a keg (not shown) and a tap connection port 5 which connects to the tap in the bar. In the illustrated embodiment, ports 4 and 5 are adjacent to each other but it is to be appreciated that the three ports may be provided at different positions and/or orientations to each other and are not limited to this configuration. The valve system comprising a valve chamber VC and a plurality of movable seals (discussed in further detail below) is provided between the bowel chamber 6 and the three ports 3, 4, 5 and the spring-mounted button 18 actuates the valve system to alter fluid flow through the different ports. In particular, the actuator and valve system simultaneously close the tap connection port 5 and open the purging port 3, or vice versa. The opening of the purging port 3 (See FIG. 3C) by the actuator and valve system also simultaneously provides a fluid pathway (See Y to Y in FIG. 3C) between the fluid container connection port 4 and the ball valve or float so that the ball valve/float is pushed off its sealing surface 9 in FIG. 3C.

The main body part 2 is screwed on to the bowel chamber 6 and has an O ring 7 forming a seal between the two parts. Each port has an inlet/exit into the valve chamber VC. One is an inlet/exit that is provided between valve chamber and a body tube 10 which extends substantially the length of the bowel chamber with an outlet at the highest point inside the bowel 6. The second and other inlet/exit is provided between the valve chamber VC and the base of the bowel chamber 6 where there is an O ring seal 9. The O ring 9 is also a seal at the base of the bowel.

In this embodiment, the valve system comprises a spool valve 11 consisting of a cylinder inside a sealed outer case, with a series of chambers drilled through the case to form valve ports. A series of O ring seals 12 are provided to ensure that no fluid leaks to atmosphere and into the wrong port. There is an end cap 14 that acts as a stop for the spool valve 11 and a locator for a spring 19 (See FIG. 3A) and at the other end of the spool valve 11 there is a sealing surface and end cap 15 with a seal 16 which seals against the body 2. The inner parts are held in place by retaining nuts 17 provided at each end of the spool valve.

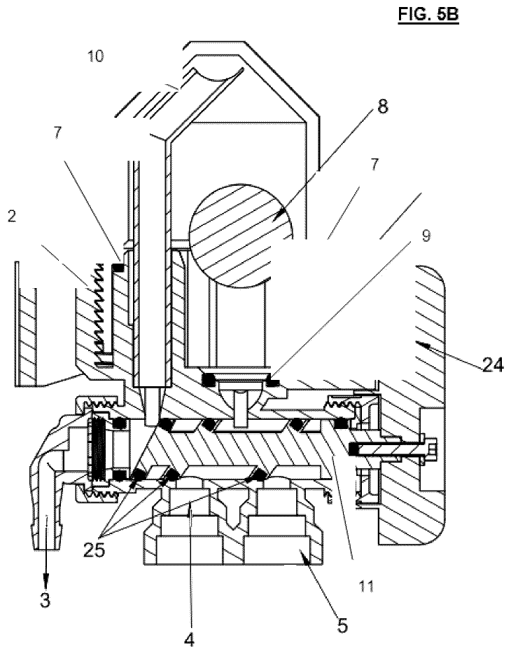

The function of the spool valve 11 is to move within the sealed case and provide the function of either blocking or opening the ports into and out of the valve chamber, depending upon the position of the spool. In the illustrated embodiment, the spool is moved by the button 18 but other types of manual actuator may be used, such as a lever (see FIGS. 5A to 5B) or an automatic system may be used such as a solenoid actuator connected to a control system or a disc valve mechanism.

FIG. 3A shows the assembled FOB detector 1 when in the liquid dispensing mode, during which liquid is able to travel from a keg to a tap at the bar through the fluid line. The ball valve 8 floats on the liquid in the bowel chamber 6. The liquid in the bowel chamber 6 then flows onwards to the tap in the bar via the tap connection port 5. The flow of liquid through the FOB detector 1 is shown by the bold arrows X at the keg connection port 4. The spool valve 11 is in its normal working position. The spool valve 11 is providing a fluid pathway between the keg connection port 4, the body tube 10, the bowel chamber 6 and then finally to the tap connection port 5. The spool valve 11 is being held in this position by both the keg pressure on the spool valve 11 which is pushing it to the right and a spring 19 that is also pushing the button 18 to the right. The spool valve 11 is connected to the button 18 and the end cap 14 acts as a stop for the spool valve 11 and a locator for the spring 19. At the left-hand end of the spool valve 11 there is a sealing surface and end cap 15 with a seal 16 which seals against the body 2. The sealing surface an end cap 15 with the spool valve 11 in this position means no liquid can escape into the FOB or purging port 3 and FOB exit 14.

FIG. 3B shows the assembled FOB detector 1 when it is connected to an empty keg. When the keg becomes empty the bowel chamber 6 also becomes empty and the ball valve or float 8 sinks to the bottom of the bowel chamber 6. The ball valve 8 then forms a seal with the ball valve to body seal 9. This prevents any gas and foam from entering the tap connection port 5. Therefore, when the tap in the bar is turned on nothing comes out preventing people from getting splashed with gas and foam. It is then necessary to replace the empty keg with a new, full keg.

FIG. 3C shows the assembled FOB detector 1 when it has just been connected to a new, full keg. The FOB detector 1 in this position is purging out the gas and foam from the tube between the keg and the FOB detector. The purging of this tube is required because there is gas and foam in this part of the tube from the previous empty keg. The full new keg is connected at the keg connection port and then the button 18 is pushed in (represented by arrows P) which compresses the spring 19 and in turn moves the spool valve 11 to the left. In this position, the spool valve 11 closes the tap connection port 5, opens the fob exit or purging port 3 to atmosphere and opens the keg connection port 4 to the valve chamber area under the ball valve 8. In this position, the ball valve or float 8 is pushed off the seal 9 by the pressure from the full new keg. This important feature of using the pressure of the keg to release the ball valve 8 from the seal 9 is a key feature in this invention. This means that the waste gas and foam in the tube from the previous empty keg can be purged and come out through the FOB exit or purging port 3, as illustrated by the bold arrows Y. Purging is complete when the bowel 6 is filled with liquid from the new full keg and the ball valve 8 is now floating away from the ball valve to body seal 9. The button 18 can then be released and the FOB detector is able to dispense liquid as described in relation to FIG. 3A, by the spool valve moving to the right to re-open the tap connection port 5 and close off the purging port 3.

Thus, the spool valve provided in a FOB detector according to the preferred embodiment of the present invention provides the following functions:
1. Switching on and off the supply to the tap;
2. Switching on and off the purging fluid to atmosphere; and
3. Switching the keg fluid supply from into the top of the bowel via the tube in the bowel to under the ball valve.

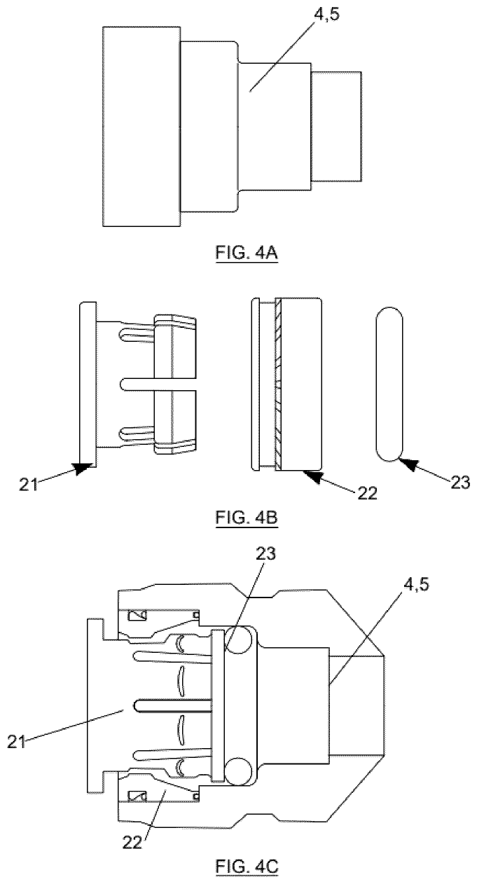

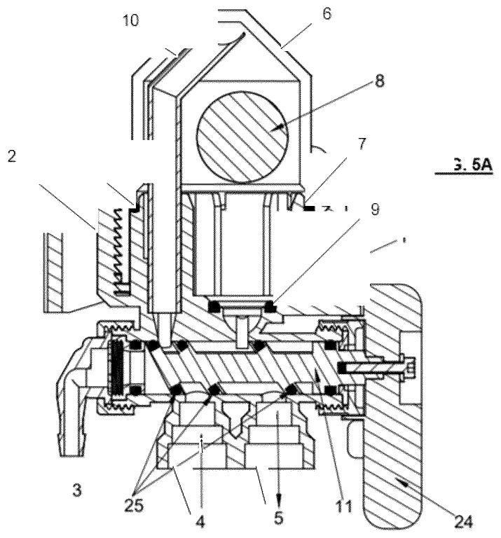

FIGS. 4A to 4C show a fixing assembly which may be used to quickly connect the fluid lines to the keg connection 4 and tap connection 5 ports. FIG. 4A shows the profile of the keg connection 4 or tap connection 5 port prior to fitting of the assembly. FIG. 4B shows three parts that make up the speed fitting assembly comprising a gripper moulding 21, an O ring 23 and a retaining moulding 22. The gripper moulding 21 grips the fluid line tube when it is fitted, and prevents it from sliding out The O ring 23 is provided to form a seal between the fluid line tube and either the keg connection port 4 or the tap connection port 5 in the FOB detector and the retaining moulding 22 keeps all the parts in place once assembled, as illustrated in FIG. 4C. Thus, the fixing assembly allows for simple and quick connection of a new keg to the detector.

FIGS. 5A and 5B of the accompanying figures illustrate an alternative embodiment of a FOB detector 1 according to the present invention. Identical features already described in relation to FIGS. 2A to 3C are given the same reference numerals and only the differences will be described in detail. The detector again includes a spool valve 11 but in this embodiment the valve has angled O rings 25 and the actuator comprises a lever or handle 24. As shown in FIG. 5A, when the handle 24 is in the lower position, both the keg connection port 4 and tap connection port 5 are open and liquid flows up the tube 10 past the floating ball valve 8 and out through the tap connection port 5. The FOB exit or purging port 3 is closed. Once the keg is empty, the ball valve or float drops to the bottom of the bowel chamber 6 sealing off flow through the tap connection port (not shown). A new keg can then be connected by transferring the keg connector to the keg connection port 4. A purging step is then carried out as illustrated in FIG. 5B, wherein the handle 24 is rotated upwardly to alter the position of the angled O rings of the spool valve, closing off the tap connection port 5 and creating a fluid pathway between the keg connection port and the bottom of the ball valve. Fluid from the new keg is able to enter through the keg connection port 4 in order to then purge the gas and liquid in the tube between the keg and the FOB detector. The pressure from the new keg enters through the keg connector port 4 forcing the ball valve 8 off the seal and then the gas and liquid flows out through the FOB exit or purging port 3. Once all the gas and liquid have been purged, the handle 24 is returned to its original position (see FIG. 5A), opening the tap connection port 5 and liquid will then flow through the FOB detector as the ball valve 8 now stays a float.

The key change in operation that is provided by the novel FOB detector of the present invention occurs when purging a new full keg as the gas and liquid that is between the new full keg and the ball valve is used to lift the ball valve off the sealing surface, while simultaneously closing off delivery to the tap in the bar but opening up an exit to atmosphere for the gas and liquid to escape (“purging port”). In the illustrated embodiments, this change of flow is done by an axial spool valve (as described in FIGS. 2A to 3D of the drawings) or a rotational spool valve with angled O rings (as described in FIGS. 5A to 5B of the drawings). However, other mechanisms may be used to simultaneously open and close the valves, such as a rotational disc valve or a rotational cam which opens and closes valves. Thus, the present invention reduces the number of user actions required in operating the FOB detector. The prior art generally requires 6 operations compared to only 3 operations with the present invention.

The invention removes the need for an additional button or other actuator on the body of the FOB detector which has to be operated after purging to break the seal of the ball valve on at the bottom of the bowel chamber. This means that this button cannot be left in the up position by mistake, which nullifies the operation of the FOB detector and may result in people getting splashed in the bar. The present invention does not require this additional button at the bottom of the body because when the spool valve is moved to its second position for purging the pressure from the keg lifts the ball valve off the seal.

Thus, the present invention provides a FOB detector that is used to ensure that no unwanted gas and foam (FOB) comes out of the tap in the bar when a keg becomes empty. This invention simplifies the method of operating the FOB detector. It has a shut off ball that floats inside the FOB detector bowel but when a keg becomes empty the ball sinks and forms a seal to prevent anything entering the port to the tap. The FOB detector has a spring-loaded button or handle which operates a spool valve, a disc valve or a spring-loaded valves with a cam to simultaneously open and close valves.

Further modifications to foam on beer detector for a beer dispensing apparatus may be made without departing from the principles embodied in the examples described and illustrated herein.

1. A foam on fluid detector comprising a bowel chamber arranged to provide a fluid pathway between a fluid container connection port and a tap connection port, the bowel chamber having a ball valve or float that in a seated position closes the fluid pathway between the container and tap connection ports, the detector further comprising a purging port and a control chamber between the ports, wherein the control chamber has a valve system operable by an actuator to simultaneously open and close at least two of the ports to alter fluid flow through the ports.

2. The detector as claimed in claim 1, wherein the actuator and valve system simultaneously close or open the tap connection port while respectively opening or closing the purging port.

3. The detector as claimed in claim 2, wherein opening of the purging port by the actuator and valve system simultaneously provides a fluid pathway between the fluid container connection port and the ball valve or float.

4. The detector as claimed in claim 1 wherein the valve system comprises a rotating disc valve or cam that opens spring loaded valves.

5. The detector as claimed in claim 1 wherein the valve system comprises a spool valve, the actuator affecting axial or rotational movement of the spool valve to simultaneously open and close two or more of the ports.

6. (canceled)

7. The detector as claimed in claim 5, wherein the valve system includes seal members comprising O rings, wherein the seal members are angled or perpendicular to the spool valve.

8. The detector as claimed in claim 1, wherein the actuator is selected from a button, a switch and a lever.

9. The detector as claimed in claim 5 wherein the actuator is selected from one of (i) a button connected to one end of the spool valve for axial movement of the spool valve and (ii) a lever or handle rotation of which causes rotational movement of the spool valve.

10. (canceled)

11. The detector as claimed in claim 1, wherein an automatic actuator comprising a solenoid is connectable to the valve system.

12. The detector as claimed in claim 1, wherein the detector comprises a main body port for receiving the bowel chamber and wherein a seal member is provided between the main body part and the bowel chamber, the main body part including the connection ports, purging port, control chamber with valve system and the actuator.

13. The detector as claimed in claim 12, wherein the main body part includes the connection ports, purging port, control chamber with valve system and the actuator.

14. The detector as claimed in claim 1, wherein a tube is provided from the control chamber to the top of the bowel chamber.

15. The detector as claimed in claim 1, wherein the fluid container connection port and the tap connection port are provided adjacent one another, below the control chamber.

16. The detector as claimed in claim 1, wherein the detector has a dispensing position, an automatic shut-off position and a purging position, the shut-off position being affected by seating of the ball valve or float at the base of the bowel chamber due to a lack of fluid flow from the fluid container, and wherein actuation of the valve system switches the detector between the dispensing position and the purging position.

17. The detector as claimed in claim 16, wherein the actuator is biased towards the dispensing position.

18. A fluid container comprising a keg incorporating a foam on fluid detector according to claims 1.

19. A fluid dispensing system comprising;
a container of pressurized gas;
a gas line connected to the container of pressurized gas and to a container containing a fluid to be dispensed;
a fluid line from the container to the fluid container connection port of a foam on fluid detector according to any one of the preceding claims; and
a fluid line from the tap connection port of the foam on fluid detector to a tap for dispensing fluid through the tap.

20. The dispensing system as claimed in claim 19, wherein at least one pressure regulator is provided in the gas line between the pressurized gas container and the fluid container.

21. A method of dispensing a fluid from a container to a tap, the method comprising:
delivering pressurized gas to a container of fluid;
delivering pressurized fluid to a fluid container connection port of a foam on fluid detector according to claim 1, wherein the fluid lifts the ball valve or float in the bowel chamber of the detector for delivery of fluid to the tap connection port; and
delivering fluid through the tap connection port to a tap for dispensing of the fluid until the container is empty wherein the ball valve or float falls to the bottom of the bowel chamber to prevent gas and fluid flow to the tap connection port;
the method further comprising replacing the empty fluid container with a full container and activating the actuator of the detector to simultaneously open the purging port and lift the ball valve or float.

22. The method according to claim 21, further comprising activating the actuator to open the purging port, said activation simultaneously operating the valve system to provide a fluid pathway from the fluid container connection port to an underside of the ball valve in the bowel chamber of the detector, whereby pressure from the fluid container pushes the ball valve off its seal and unwanted gas and foam/fob flows from the container into the bowel chamber; and deactivating the actuator to simultaneously close the purging port, redirect the fluid coming in from the fluid container to go from under the ball valve to go through a tube inside the bowel chamber and re-open the tap connection port, allowing fluid flow from the fluid container to the tap.

23. (canceled)
